(19) United States
(12) Patent Application Publication
(10) Pub. No.: US 2026/0337122 A1
(43) Pub. Date: Oct. 29, 2026

(54) BENEFICIATING SODIUM SULFATE-CONTAINING MATERIAL

(71) Applicant: U.S. Borax Inc., Wilmington, DE (US)

(72) Inventors: Sandip Shinde, Wilmington (DE); Elizabeth Gingras-Lafleur, Wilmington (DE); Judi Becker, Wilmington (DE); Fabiano Silvestrin, Wilmington (DE)

(21) Appl. No.: 19/110,208

(22) PCT Filed: Sep. 13, 2023
(86) PCT No.: PCT/US2023/032625

§ 371 Date: Mar. 10, 2025

Related U.S. Application Data
(60) Provisional application No. 63/406,707, filed on Sep. 14, 2022.

(51) Int. Cl. C05D 1/02; C05G 5/12

(52) U.S. Cl. CPC C05D 1/02; C05G 5/12

(57) ABSTRACT

A process for beneficiating a sodium sulfate-containing material that comprises processing a sodium sulfate-containing material and potassium chloride and forming potassium sulfate, i.e. sulfate of potash (SOP) as a marketable product.

### CROSS REFERENCE TO RELATED APPLICATION

This Application claims priority to U.S. Provisional Application No. 63/406,707 filed on Sep. 14, 2022.

### TECHNICAL FIELD

The present disclosure relates to beneficiating a sodium sulfate-containing material and producing a marketable product.

The present disclosure relates particularly, although by no means exclusively, to beneficiating a sodium sulfate-containing waste material and producing a marketable product.

The present disclosure also relates particularly, although by no means exclusively, to a process for producing potassium sulfate, i.e. sulfate of potash (SOP), from a sodium sulfate-containing material, such as a sodium sulfate-containing waste material.

The present disclosure also relates particularly, although by no means exclusively, to beneficiating a sodium sulfate-containing material, such as a sodium sulfate-containing waste material and producing SOP and using the SOP to produce a fertiliser product comprising SOP and boron, referred to herein as a SOP+B fertiliser product.

The present disclosure also relates particularly, although by no means exclusively, to a plant for producing a fertiliser product that comprises potassium sulfate (sulfate of potash or “SOP”) and boron, with the potassium sulfate being produced by beneficiating a sodium sulfate-containing material, such as a sodium sulfate-containing waste material.

### BACKGROUND

The following description focuses on sodium sulfate-containing material that is regarded as a waste material.

The invention is not confined to sodium sulfate-containing waste material and extends to any sodium sulfate-containing material.

Sodium sulfate is produced as a part of by-products of a number of industrial processes, including processes for producing borates and/or lithium from borate-containing minerals, lithium-containing minerals, and borate/lithium-containing minerals and processes for producing boric acid from borate-containing minerals.

Sodium sulfate can be a part of bleed or tailings streams from industrial processes and, typically, is contained in storage ponds and tailings dams of those operations. Sodium sulfate can be a part of any other suitable sodium sulfate-containing waste material streams from industrial processes.

Although sulfate ions are not considered hazardous, in a number of jurisdictions there are sulfate limitations on disposal of sulphates to reduce the environmental strain caused by an increase in saline concentrations of natural waters, especially fresh waters.

The applicant has developed a process for beneficiating sodium sulfate-containing waste material streams from sodium sulfate-containing waste material sources and producing marketable potassium sulfate, i.e. sulfate of potash (SOP).

It is understood that the above description is not to be taken as an admission of the common general knowledge anywhere.

### SUMMARY OF THE DISCLOSURE

The present disclosure provides a process for beneficiating a sodium sulfate-containing material that comprises processing a sodium sulfate-containing material and potassium chloride and forming potassium sulfate, i.e. sulfate of potash (SOP), as a marketable product.

The term “marketable product” is understood herein to mean a product that can be sold to the market. The term “marketable product” is understood herein to include SOP that can be sold to the market as a fertiliser or as a feed material for the production of a fertiliser product.

The present disclosure also provides a process for producing potassium sulfate, i.e. sulfate of potash (SOP), that comprises processing a sodium sulfate-containing material and potassium chloride and forming SOP.

The sodium sulfate-containing material may be a sodium sulfate-containing material that is regarded as a waste material.

The sodium sulfate-containing material may be obtained from any suitable sodium sulfate-containing material, including any suitable source of sodium sulfate-containing waste material.

By way of example, the waste material source may be mineral processing operations such as borates production processes, lithium production processes, borates/lithium production processes, and boric acid production processes.

The waste material source may be existing storage ponds and tailings dams of the operations described above.

The process may comprise processing the sodium sulfate-containing material, such as a sodium sulfate-containing waste material, and potassium chloride in a Glaserite process and forming SOP.

The Glaserite process is a two-stage process for converting sodium sulfate into potassium sulfate, with the following reactions (1) and (2) in each respective stage 1 and 2:

6 KCl+4 Na₂SO₄ [symbol] 2 K₃Na(SO₄)₂+6 NaCl (1)

2 KCl+2 K₃Na(SO₄)₂ [symbol] 4 K₂SO₄+2 NaCl (2)

In stage 1, sodium sulfate reacts with KCl at near ambient temperature in accordance with reaction (1) and produces a reaction slurry comprising Glaserite solids (K₃Na(SO₄)₂) and a soluble sodium chloride solution.

In stage 2, the Glaserite solids and a KCl solution are mixed together and allowed to react at near ambient temperature in accordance with reaction (2) and produce a reaction slurry containing potassium sulfate (SOP) solids. The SOP solids are separated from the slurry and are dried to produce a dry powdered product.

The present disclosure also provides a SOP+B fertiliser product which provides a macronutrient and a micronutrient.

The SOP+B fertiliser product of the disclosure allows farmers to use a single fertiliser product to correct potassium and sulphur deficiencies in soils while providing boron in sufficient quantities for plant growth in crops.

The exact quantity of boron in the fertiliser product can be selected based on the boron demand of the plant in crops.

According to the present disclosure, there is also provided a fertiliser product comprising (a) potassium sulfate (sulfate of potash or “SOP”) produced from a sodium sulfate-containing material source and potassium chloride and (b) boron, wherein the amount of boron is equivalent to 0.2 to 3.0 wt. % B.

The sodium sulfate-containing material may be a sodium sulfate-containing material that is regarded as a waste material.

The amount of boron in the fertiliser product may be equivalent to more than 0.5 wt. % B.

The amount of boron in the fertiliser product may be equivalent to more than 0.6 wt. % B.

The amount of boron in the fertiliser product may be equivalent to more than 0.9 wt. % B.

The amount of boron in the fertiliser product may be equivalent to no more than 10 wt. % B.

The amount of boron in the fertiliser product may be equivalent to no more than 7 wt. % B.

The amount of boron in the fertiliser product may be equivalent to no more than 1.75 wt. % B.

The amount of boron in the fertiliser product may be equivalent to no more than 1.5 wt. % B.

The amount of boron in the fertiliser product may range from 5 to 7 wt. % B.

The fertiliser product may comprise boron in any one or more than one of the boron-containing compounds boric acid, borax pentahydrate, anhydrous borax, boric oxide, kernite, ulexite, borax decahydrate, zinc borate, tincal and disodium octaborate tetrahydrate (DOT) or combinations thereof.

The fertiliser product may comprise a micronutrient in addition to boron.

The fertiliser product may further comprise an additional micronutrient selected from a group consisting of iron, molybdenum, cobalt, manganese, nickel, copper, zinc or a combination thereof.

The additional micronutrient may be any suitable micronutrient such as zinc.

The zinc may be in a form of zinc acetate, zinc fluoride, zinc bromide, zinc nitrate, zinc chloride, zinc iodide, zinc oxide, zinc permanganate, zinc sulfate heptahydrate, zinc sulfate monohydrate, zinc sulfite, zinc tartrate, zinc oxysulfate, zinc EDTA, and zinc ammonia salts.

The additional micronutrient may be any one of the following micronutrients in the following forms:
1) Micronutrient iron: iron (II) carbonate, iron (II) nitrate, iron (II) chloride, iron (II) hydroxide, iron (II) oxalate, iron (II) sulfate, iron (III) chloride, iron (III) fluoride, iron (III) hydroxide, iron (III) nitrate, iron (III) sulfate, iron EDTA.
2) Micronutrient manganese: manganese (II) bromide, manganese (II) carbonate, manganese (II) chloride, manganese (II) hydroxide, manganese (II) nitrate, manganese (II) fluoride, manganese (II) oxalate, manganese (II) sulfate, manganese oxy-sulfate, manganese EDTA.
3) Micronutrient copper (not commonly needed): copper (I) chloride, copper (I) hydroxide, copper (I) iodide, copper (I) sulfide, copper (I) oxide, copper (II) fluoride, copper (II) bromide, copper (II) carbonate, copper (II) chloride, copper (II) hydroxide, copper (II) nitrate, copper (II) oxide, copper oxalate, copper (II) sulfate, copper (II) sulfide, copper EDTA.
4) Micronutrient molybdenum: ammonium molybdate, molybdenum trioxide, molybdenum disulfide, calcium molybdate, magnesium molybdate.
5) Micronutrient nickel: nickel sulfate, nickel bromide, nickel carbonate, nickel chloride, nickel fluoride, nickel formate, nickel hydroxide, nickel iodide, nickel nitrate, nickel oxalate, nickel sulfate.
6) Micronutrient cobalt (not commonly needed): cobalt (II) fluorosilicate, cobalt (II) iodide, cobalt (II) nitrate, cobalt (II) nitrite, cobalt (II) oxalate, cobalt (II) sulfate, cobalt (II) chloride, cobalt (II) bromide, cobalt (II) fluoride.

The fertiliser product may comprise a macronutrient in addition to potassium and sulphur.

The additional macronutrient may be any one of the following macronutrients in the following forms:
1) Macronutrient phosphorous: super phosphate, concentrated super phosphate, mono-ammonium phosphate, di-ammonium phosphate, ammonium polyphosphate, phosphoric acid, phosphorous acid, phosphonic acids, bone ash, bone meal, rock phosphates.
2) Macronutrient magnesium: magnesium acetate, magnesium bromide, magnesium carbonate, magnesium chloride, magnesium formate, magnesium hydroxide, magnesium fluoride, magnesium iodide, magnesium nitrate, magnesium oxalate, magnesium oxide, magnesium phosphate, magnesium sulfate, magnesium sulfite, magnesium thiosulfate, magnesium selenite.
3) Macronutrient calcium: calcium acetate, calcium benzoate, calcium bicarbonate, calcium bromide, calcium carbonate, calcium fluoride, calcium chloride, calcium citrate, mono-calcium phosphate, calcium formate, di-calcium phosphate, calcium hydroxide, calcium iodide, calcium nitrate, calcium nitrite, calcium oxalate, calcium oxide, calcium phosphate, calcium selenite, calcium sulfate.

The fertiliser product may be in a form of granules or pellets.

The term “granule” is understood herein to mean a small compact particle of material, which may have a regular or irregular shape.

A granule may be formed by agglomeration or compaction or otherwise, which may further be followed by crushing.

The term “pellet” is understood herein to mean a particle of material, which suitably has a regular shape. A pellet may be formed by compression or compaction or molding or otherwise.

The granules or pellets may be formed to provide required mechanical properties for materials handling of the granules or pellets.

The granules or pellets may be compacted in a compaction or dry granulation process.

Alternatively, the granules or pellets may be compacted using other granulation processes, such as wet granulation in a disc or other suitable pelletizer or fluidized bed or high energy mixing granulator.

The granules or pellets may be 1-5 mm in size, typically 2-4 mm in size.

The fertiliser product may be a slow-release product.

The term “slow-release” is understood herein to mean the release of nutrients in the soil occurs gradually over a period of time because the nutrients are in a form that is not readily available for plant uptake in crops until some time has elapsed after the fertiliser has been applied.

The fertiliser product may be a controlled-release product.

The term “controlled-release” is understood herein to mean the release of nutrients in the soil is controlled to match the dynamic nutrient requirements in crops. Controlled-release fertilisers typically contain water-soluble nutrients that are coated or encapsulated with a material that controls the rate of nutrient release in crops. The coating is typically a semi-permeable material that allows the rate, pattern and duration of nutrient release to be controlled.

The fertiliser product may comprise granules or pellets and a coating to control the release of macronutrients and micronutrients from the granules or pellets.

The coating may be made from any suitable material.

The coating may be made from a polymeric material.

The coating may be made from a sulphur-containing polymer material.

The coating may include any one of the following materials.
Inorganic materials: bentonite, phosphogypsum, gypsum, hydroxy apatite, zeolites, sepiolite.
Synthetic polymers: polyurethane, polyethylene, polyacrylamide, polycaprolactone, polystyrene, polysulfone, aliphatic polyester, polyvinyl alcohol, bio-based epoxy.
Natural polymers: starch, cellulose, chitosan, ethyl cellulose, carboxymethyl cellulose, hydroxy methyl cellulose, hydroxypropyl methylcellulose, bio-based polyurethane, polysulfone, latex, natural rubber, lignin, alginate.
Hydrophobic sealants: paraffin, polyols.

The coating may be formed by any one of the following coating techniques: rotary drum, pan, fluidized bed, melting and extrusion, solution polymerization and crosslinking, inverse suspension polymerization, and microwave irradiation.

The fertiliser product may further comprise a binder.

The binder may be any suitable material.

The binder may be a starch.

The binder may be water.

According to the present disclosure, there is also provided a process for producing a fertiliser product comprising:
(a) blending together, for example by dry mixing or wet mixing, (i) potassium sulfate (sulfate of potash or “SOP”) produced from a sodium sulfate-containing material source and potassium chloride and (ii) one or more than one boron-containing compound; and
(b) compacting, agglomerating or otherwise forming the blended potassium sulfate and boron-containing compound(s) into granules or pellets.

Water may be added during the blending step (a).

The sodium sulfate-containing material may be a sodium sulfate-containing material that is regarded as a waste material.

The potassium chloride may be obtained from any suitable source.

When blending step (a) is a dry mixing step, the process may comprise adding up to 30 wt. % moisture before forming step (b). Suitably, the process comprises adding up to 20 wt. % moisture before forming step (b). More suitably, the process comprises adding up to 10 wt. % moisture before forming step (b). Even more suitably, the process comprises adding up to 2 wt. % moisture before forming step (b).

When blending step (a) is a wet mixing step, the process may include drying the blended potassium sulfate and boron-containing compound(s) to form a mixture having a moisture content of not more than 30 wt. % before forming step (b). Suitably, the process comprises drying the blended potassium sulfate and boron-containing compound(s) to form a mixture having a moisture content of not more than 20 wt. % before forming step (b). More suitably, the process comprises drying the blended potassium sulfate and boron-containing compound(s) to form a mixture having a moisture content of not more than 10 wt. % before forming step (b). Even more suitably, the process comprises drying the blended potassium sulfate and boron-containing compound(s) to form a mixture having a moisture content of not more than 2 wt. % before forming step (b).

The process may include drying the granules or pellets.

The SOP and the boron-containing compound(s) may be dry powders.

The process may comprise producing SOP from a sodium sulfate-containing material, such as a sodium sulfate-containing waste material, by the above-described process.

The SOP may be produced by a Glaserite process.

The process may comprise supplying a sodium sulfate waste material and potassium chloride as feed materials for the Glaserite process and forming SOP.

The boron-containing compound(s) may be selected from any one or more than one of boric acid, borax pentahydrate, anhydrous borax, boric oxide, kernite, ulexite, borax decahydrate, zinc borate, tincal and disodium octaborate tetrahydrate (DOT) or a combination thereof.

Blending step (a) may comprise mixing a binder with potassium sulfate and the boron-containing compound(s).

The binder may be a starch.

The binder may be water.

Blending step (a) may be a bulk blending step in which the compounds are added together at the same time and then mixed together.

Blending step (a) may comprise any suitable sequence of adding and mixing the compounds.

The process may comprise crushing the granules or pellets produced in the granule/pellet-forming step (b).

The process may comprise classifying, for example screening, the crushed granules or pellets and separating the classified granules or pellets on the basis of size and producing a product fraction.

The process may comprise classifying, for example by screening, the crushed granules or pellets into an oversize fraction, a product fraction, and an undersize fraction.

The product fraction may be any suitable size fraction.

The product fraction may be at least 1 mm.

The product fraction may be at least 2 mm.

The product fraction may be no more than 6 mm.

The product fraction may be no more than 5 mm.

The product fraction may be no more than 4 mm.

The product fraction may be a 1-4 mm size fraction.

The product fraction may be a 1-5 mm size fraction.

The product fraction may be a 1-6 mm size fraction.

The process may comprise returning the oversize fraction to the crushing step.

The process may comprise returning the undersize fraction to the granule/pellet-forming step (b).

The process may comprise drying the product fraction to form the fertiliser product.

The present disclosure also provides a process for producing a fertiliser product that comprises potassium sulfate (sulfate of potash or “SOP”) and boron, the process comprising:
(a) blending together (i) SOP produced from a sodium sulfate material source, such as a sodium sulfate waste material source, and potassium chloride and (ii) one or more than one boron-containing compounds and optionally other micronutrients,
(b) compacting or otherwise forming the blend into granules or pellets,
(c) screening or otherwise classifying the granules or pellets and forming a product fraction, and
(d) drying the granules or pellets in the product fraction and forming the fertiliser product.

Water may be added during the blending step (a).

The process may comprise crushing the granules or pellets produced in the granule/pellet-forming step.

The classifying step (c) may comprise producing an oversize fraction, an undersize fraction, and a product fraction.

The process may comprise a crushing step after classifying step (c). Suitably, the process comprises returning the crushed material after the screening step to the blending step. The crushed material may comprise either or a mixture of crushed oversize material and undersized material.

The process may comprise returning the oversize fraction to the granule/pellet-forming step (b).

The process may comprise returning the undersize fraction to the compaction step.

The present disclosure also provides a plant for producing a fertiliser product that comprises potassium sulfate (sulfate of potash or “SOP”) and boron, the plant comprising:
(a) a unit for producing SOP from a sodium sulfate material source, such as a sodium sulfate waste material source, and potassium chloride,
(b) a blending unit blending together (i) SOP produced in SOP production unit (a) and (ii) one or more than one boron-containing compounds and optionally other micronutrients,
(c) a compaction unit or other suitable unit for forming the blend into granules or pellets,
(d) a screening unit or other classification for screening the granules and pellets and producing a product fraction; and
(e) drying the granules or pellets in the product fraction and forming the fertiliser product.

The SOP production unit (a) may be a Glaserite process unit.

The plant may comprise a crushing unit for crushing the granules or pellets produced in the compaction unit or other suitable granule/pellet-forming unit.

The crushing unit may be used to crush the compacted material from the compaction unit or other suitable granule/pellet-forming unit (c).

### BRIEF DESCRIPTION OF THE DRAWINGS

The present disclosure is described further by way of example with reference to the accompanying drawings, of which:

FIG. 1 is a flowsheet illustrating one embodiment of a process and a plant for producing a SOP+B fertiliser product according to the present disclosure;

FIG. 2 is a flowsheet illustrating another embodiment of a process and a plant for producing a SOP+B fertiliser product according to the present disclosure;

FIG. 3 is a flowsheet illustrating another, but not the only other, embodiment of a process and a plant for producing a SOP+B fertiliser product according to the present disclosure; and

FIG. 4 is a flowsheet illustrating one embodiment of the steps in the granulation process and a plant of FIG. 1 according to the present disclosure.

### DESCRIPTION OF EMBODIMENTS

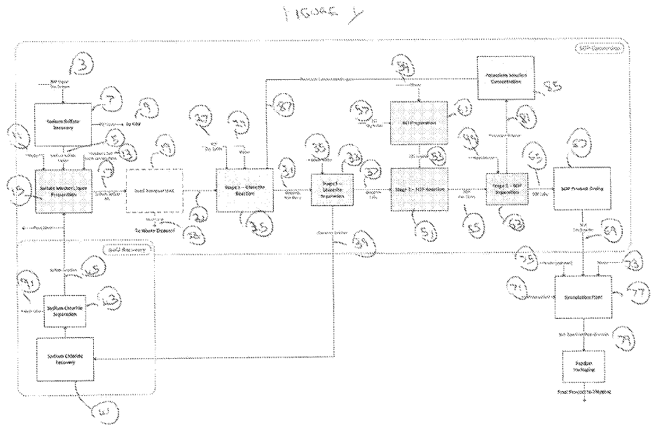

FIG. 1 is a process flowsheet of one, but not the only, embodiment of a process and a plant of the present disclosure.

The flowsheet shown in FIG. 1:
(a) beneficiates a sodium sulfate-containing material, in this instance a sodium sulfate-containing waste material, by processing a sodium sulfate-containing waste material stream and potassium chloride in a Glaserite process and forming potassium sulfate, i.e. sulfate of potash (SOP), and
(b) produces a fertiliser product for use as a micronutrient enriched fertiliser, general fertiliser, or crops nutrient in soil applications from the SOP produced in the above stage (a).

With reference to FIG. 1, a feed material for the process is a mother liquor slip stream 3 sourced from a boric acid plant (BAP)—not shown.

The BAP mother liquor slip stream 3 contains sodium sulphate, sodium sulfate, boric acid and other impurities, and boric acid in concentrations depending on the composition of the borate ore and the temperature at which the boric acid is recovered.

It is noted that the disclosure is not confined to sourcing sodium sulphate from a BAP mother liquor slip stream 3. Nevertheless, the use of this source of sodium sulfate is a useful end-use for the BAP mother liquor slip stream 3, which would otherwise be a waste material stream in the BAP.

The disclosure extends to the use of sodium sulfate-containing waste streams that are sourced from any suitable sodium sulfate-containing waste material sources.

The disclosure also extends to the use of sodium sulfate-containing streams that are sourced from any suitable sodium sulfate-containing material sources that are not necessarily sodium sulfate-containing waste streams.

The feed material 3 is transferred to a sodium sulfate recovery unit 7 and formed into a sodium sulfate concentrate liquor 5 and a boric acid (BA) liquor 9.

The sodium sulfate recovery unit 7 may be any suitable unit. Examples of suitable units include a reverse osmosis (RO) and/or a nanofiltration membrane unit, an evaporator and a crystalliser.

The boric acid (BA) liquor 9 is recycled to the BAP.

The sodium sulfate concentrate liquor 5 is transferred to a sulfate mother liquor preparation unit 15.

The sodium sulfate concentrate 5, water 11, Glauber's salt (sodium sulfate decahydrate or Na₂SO₄·10H₂O) 13, and a sodium sulfate solution 45 are mixed together in the unit 15 and produce a sodium sulfate mother liquor (ML) 17. By way of example, the sulfate mother liquor preparation unit 15 is a mixing tank.

The Glauber's salt stream is sourced from a lithium plant (not shown). The Glauber's salt stream would otherwise be disposed of in ponds. The disclosure is not confined to this source of Glauber's salt.

The sodium sulfate solution 45 is sourced from a downstream step in the process. The disclosure is not confined to this source of sodium sulfate.

The sodium sulfate ML 17 is transferred to a polishing filtration unit 19 or any other suitable unit that removes solid impurities and produces a product stream 21 comprising sodium sulfate in solution and a solid filter cake 23.

The filter cake 23 is a waste product.

The sodium sulfate product stream 21 is converted into potassium sulfate in a two-stage Glaserite reaction with the following reactions (1) and (2) in each respective stage 1 and 2:

6 KCl+4 Na₂SO₄ [symbol] 2 K₃Na(SO₄)₂+6 NaCl (1)

2 KCl+2 K₃Na(SO₄)₂ [symbol] 4 K₂SO₄+2 NaCl (2)

In stage 1, the sodium sulfate stream 21 reacts with potash (KCl) 27, water 29, and a concentrated potassium liquor 87 at near ambient temperature in reactor 25 in accordance with reaction (1) and produces a reaction slurry (S1) 31 comprising Glaserite solids (K₃Na(SO₄)₂) and a soluble sodium chloride solution.

The reaction slurry 31 from stage 1 is transferred to a solid-liquid separation unit 33 that recovers the Glaserite solids as a Glaserite cake 37 and produces a Glaserite solution 39.

The solid-liquid separation unit 33 may be by way of example a centrifugation step that uses wash water 35 to separate a Glaserite cake 37 from the slurry 31.

The Glaserite solution 39 contains soluble sodium chloride and is treated in a NaCl recovery unit 41 and sodium chloride separation unit 43 that produces a solid sodium chloride cake 91 and the above-described sodium sulfate solution 45. The sodium sulfate solution 45 is transferred to the sulfate mother liquor preparation unit 15 or disposed of in ponds or other disposal options.

The NaCl recovery unit 41 may include but is not limited to, an evaporative crystallization step to precipitate a NaCl solute in combination with or without a prior sulfate separation step by membrane, producing a sodium sulfate concentrate which can be used in the sulfate mother liquor preparation unit or elsewhere in the process. Other suitable technologies to replace the crystallization step may include reverse osmosis and/or nanofiltration step.

The Glaserite cake 37 produced in the solid-liquid separation unit 33 is transferred to a SOP reactor 51.

The Glaserite cake 37 and a KCl solution 53 are mixed together and allowed to react in the SOP reactor 51 at near ambient temperature in accordance with reaction (2) and produce a reaction slurry (S2) 55 containing potassium sulfate (SOP) solids and a solution containing mainly potassium chloride (from excess KCl added in stage 2), sulfates, and traces of NaCl from the reaction.

The KCl solution 53 is prepared in this embodiment by mixing potash 57 in the form of dry solids and water 59 in a mixing tank 61.

The SOP solids are separated from the reaction slurry 55 in a solid-liquid separation unit 63.

By way of example, the solid-liquid separation unit 63 is a centrifugation step. A wash water 99 is provided and this separates the solids from the reaction slurry 55 and produces an output SOP cake 65 and a centrate 81. The centrate 81 contains a high concentration of potassium and a significant but much lower amount of NaCl.

Other types of solid-liquid separation units may be used.

The centrate 81 is transferred to a potassium solution concentration unit 85 and is concentrated for example by evaporation and produces the concentrated potassium liquor 87 that is supplied to the reactor 25 to contribute to the Glaserite reaction to maximize the yield of potassium. Steam 91 produced in the concentration unit 85 can be used in various units of the SOP production process or elsewhere.

Other suitable technologies to replace the evaporation step may include reverse osmosis that could concentrate our potassium stream enough to recycle back to stage 1.

The SOP cake 65 produced in the solid-liquid separation unit 63 is dried in a dryer 67, such as a rotary dryer, forming a dry SOP powdered product 69 and steam 97.

It is advantageous to use the Glaserite process to produce SOP because, as noted above, sodium sulfate-containing waste material streams are often produced in mineral processing operations (such as the borates/lithium production operations and boric acid production operations) and are waste material sources that have to be stored in ponds, tailings dams, or otherwise disposed of by mine operators.

Currently, there are limited markets for sodium sulfate and significant amounts of sodium sulfate are produced in mineral processing operations.

The sodium sulfate waste material sources are readily available on site—either as waste material streams produced as part of continuing process operations or as stored waste material in ponds and tailings dams.

It follows from the above that the use of sodium sulfate waste material in the present disclosure is potentially beneficial to mine operators.

In addition, the use of sodium sulfate waste material is an opportunity to reduce production costs of SOP as compared to other options, such as using a Manheim process (i.e. H₂SO₄+KCl) to produce sodium sulfate, or buying sodium sulfate from other sources.

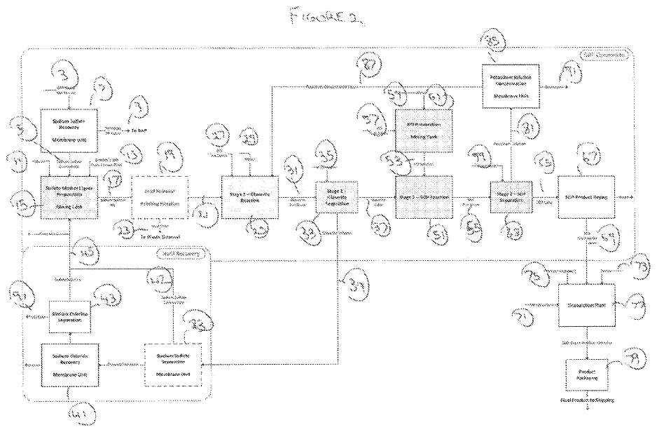

FIG. 2 is a flowsheet illustrating another embodiment of a process and a plant for producing a SOP+B fertiliser product.

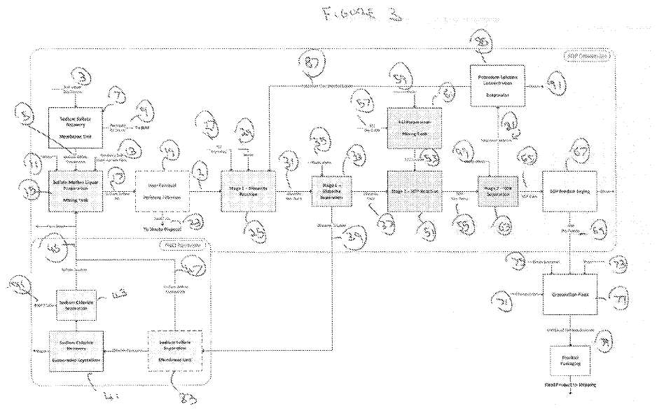

FIG. 3 is a flowsheet illustrating another, but not the only other, embodiment of a process and a plant for producing a SOP+B fertiliser product.

The same reference numerals are used in FIGS. 1-3 to describe the same features.

The flowsheets in FIGS. 1-3 are substantially the same and the following description highlights the differences between the flowsheets.

In the FIG. 2 flowsheet, the sodium sulfate recovery unit 7 is shown as a membrane unit.

In addition, the Glaserite solution 39 produced in the solid-liquid separation unit 33 is treated in a sodium sulfate separation unit 85 in the form of a membrane unit and produces a sodium sulfate concentrate 47 and a chloride containing permeate 49.

The sodium sulfate concentrate 47 is transferred to and becomes part of the sodium sulfate solution 45 that is transferred to the sulfate mother liquor preparation unit 15.

The permeate 49 is transferred to the NaCl recovery unit 41, in this embodiment in the form of a membrane unit, and the sodium chloride separation unit 43 and processed as described in relation to FIG. 1.

The FIG. 3 flowsheet is the same as the FIG. 2 flowsheet, save that the NaCl recovery unit 41 is in the form of an evaporative crystalliser rather than the membrane unit of the FIG. 2 flowsheet.

With further reference to FIGS. 1-3, the dry SOP powdered product 69 is a marketable product.

In the FIGS. 1-3 embodiments, the dry SOP powdered product 69 is used in the production of a fertiliser product, as described below.

The dry SOP powdered product 69 can also be used as a soluble fertilizer, a potassium sulfate fine powder, and/or used in the production of a granular fertilizer product.

The fertiliser product produced in the FIGS. 1-3 embodiments comprises SOP and boron, wherein the amount of boron is equivalent to 0.2 to 3.0 wt. % B.

Typically, the formulated fertiliser product produced in the FIGS. 1-3 embodiments comprises SOP and boron, with the amount of B equivalent to 0.2 to 3.0 wt. % B being selected based on the B demand of targeted crops.

The formulated fertiliser product produced in the FIGS. 1-3 embodiments may also contain other materials, including other micronutrients and a binder.

It is an important consideration in the agricultural fertiliser industry that fertiliser products contain minimum amounts of materials that provide no fertiliser benefit (e.g. starch binders). Therefore, typically, the formulated fertiliser product contains minimal amounts of such other materials.

In broad terms, the fertiliser production section of the process shown in FIGS. 1-3 comprises:
(a) blending together the dry SOP powdered product 69 and one or more than one boron-containing compounds,
(b) compacting the blend into granules or pellets; and
(c) crushing, screening and drying the granules or pellets and forming the fertiliser product.

The product formulation produced in the FIG. 1 process flowsheet is in the form of compacted granules of 1-5 mm, typically 2-4 mm granule size.

With reference to FIG. 1, the dry SOP powdered product 69 is combined with a boron-containing compound 71, water 73, and optionally a binder 75 and optionally other additional micronutrients in a granulation plant 77 and forms granules of the SOP+B final product 79.

The steam 97 produced in the rotary dryer 67 can be used in various units of the SOP production process or elsewhere.

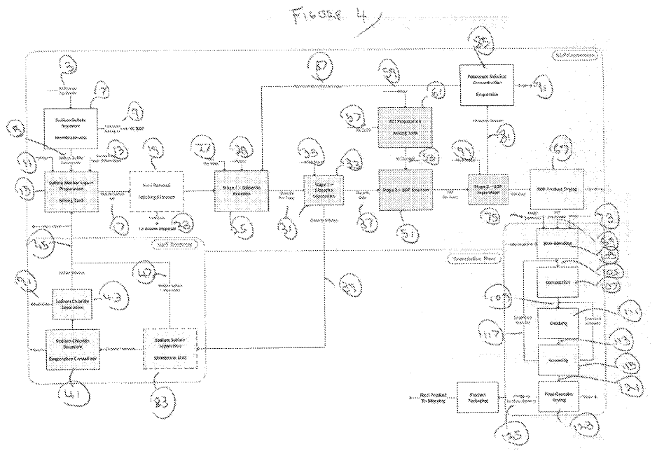

FIG. 4 is a process flowsheet illustrating steps in an embodiment, although not the only embodiment, of a granulation plant 77 according to the present disclosure.

The process steps to form the dry SOP powdered product 69 that is transferred to the granulation plant 77 are the same process steps described in relation to FIG. 1 and substantially the same process steps described in relation to FIGS. 2 and 3 are not repeated here, noting that the same reference numerals are used in FIGS. 1 and 4 to describe the same features.

A key feature of the embodiment of the process for producing the fertiliser product shown in FIG. 4 is the formulation and compaction of the SOP+B product.

With further reference to FIG. 4, the granulation plant 77 includes a bulk blending unit 103 which mixes together the dry SOP powdered product 69, boron-containing compound 71, water 75, optionally a binder 75 and optionally other micronutrients selected from the above list, in targeted proportions depending on the B nutrient crop demands and produces a blended product 105.

The blended product 105 is compacted and dried in a compaction unit 107, thereby forming granules or pellets 109. The target size of the granules or pellets 109 in the final fertiliser product is 1-5 mm, typically 2-4 mm.

The granules or pellets 109 are crushed in a crusher unit 111 and produce crushed granules or pellets 113.

The crushed granules or pellets 113 are transferred to a screen unit 115 and separated in an oversize fraction 119, and undersize fraction 117, and a product fraction 121.

The undersize fraction 117 are returned to the compaction unit 107 and re-processed.

The oversize fraction 119 are returned to the crusher unit 111 and re-crushed.

The product fraction 121, which a target size granules or pellets, are transferred to a dryer unit 123 and dried to form the final fertiliser product 125.

Many modifications may be made to the embodiments described above without departing from the spirit and scope of the invention.

By way of example, whilst the embodiment shown in the FIG. 4 includes a boron micronutrient, the disclosure is not so limited and extends to other additional micronutrients. For example, the micronutrient may be selected from a group consisting of iron, molybdenum, cobalt, manganese, copper, nickel, zinc or a combination thereof.

By way of further example, whilst the embodiment shown in FIG. 4 is a compaction or dry granulation process, the disclosure is not so limited and extends to other granulation processes. For example, the process may include wet granulation in a disc or other suitable pelletizer or fluidized bed or high energy mixing granulator.

In the embodiment of FIG. 2, the granules or pellets may be slow-release granules. By way of further example, the embodiment of the process shown in FIG. 2 may include coating the granules or pellets with a quick-release coating.

The applicant has carried out development work into the invention described above to better establish how to perform the invention at scale in an efficient manner.

The applicant has conducted bench scale (1 L) trials and batch pilot scale trials (30 L batch) to produce the SOP from sodium waste (Glauber's salt) produced on site at a lithium production plant. The trials demonstrate that it is feasible to produce a product with greater than 95% K₂SO₄ using the two-stage Glaserite process at near ambient temperatures and minimum KCl addition ratios of 0.79 g KCl/g Na₂SO₄ in stage 1 and 0.70 g KCl/g Glaserite in stage 2. The best reaction times and reagent concentrations in the reaction slurry were also determined by testing different parameters in bench scale trials.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-13. (canceled)

14. A process for beneficiating a sodium sulfate-containing material comprising:
processing a sodium sulfate-containing material and potassium chloride and forming a boron-containing potassium sulfate marketable product,
wherein the sodium sulfate-containing material is a waste material that is obtained from any one or more of borates production processes, lithium production processes, borates/lithium production processes and boric acid production processes.

15. The process of claim 14 comprising
processing the sodium sulfate-containing material and potassium chloride and forming a sulfate of potash (SOP).

16. The process of claim 15 comprising
processing the sodium sulfate-containing material and potassium chloride in a Glaserite process and forming the SOP.

17. The process of claim 15 comprising
producing the sulfate of potash (SOP) from
(a) a sodium sulfate-containing waste material that is obtained from any one or more of borates production processes, lithium production processes, borates/lithium production processes and boric acid production processes, and potassium chloride, and
(b) boron, wherein the amount of boron is equivalent to from 0.2 wt % to 3.0 wt % B.

18. A process for producing a fertiliser product comprising:
(a) blending together by dry mixing or wet mixing
(i) potassium sulfate (sulfate of potash or “SOP”) produced from a sodium sulfate-containing material that is obtained from any one or more of borates production processes, lithium production processes, borates/lithium production processes and boric acid production processes, and potassium chloride and
(ii) one or more than one boron-containing compounds and optionally one or more than one other micronutrients; and
(b) forming the blended potassium sulfate and boron-containing compound(s) into granules or pellets.

19. The process of claim 18 comprising crushing the formed granules or pellets.

20. The process of claim 19 comprising classifying the crushed granules or pellets; and
separating the crushed granules or pellets on the basis of size and forming a product fraction.

21. The process of claim 20 comprising classifying the crushed granules or pellets into an oversize fraction, a product fraction, and an undersize fraction.

22. The process of claim 21 comprising returning the oversize fraction to the crushing step.

23. A process for producing a fertiliser product that comprises potassium sulfate (sulfate of potash or “SOP”) and boron, the process comprising:
(a) blending together
(i) SOP produced from a sodium sulfate material that is obtained from any one or more of borates production processes, lithium production processes, borates/lithium production processes and boric acid production processes, and potassium chloride and
(ii) one or more than one boron-containing compounds and optionally other micronutrients,
(b) forming the blend into granules or pellets,
(c) classifying the granules or pellets and forming a product fraction, and
(d) drying the granules or pellets in the product fraction and forming the fertiliser product.
